(19) United States
(12) Patent Application Publication
(10) Pub. No.: US 2003/0114142 A1
(43) Pub. Date: Jun. 19, 2003

(54) Distributing billing for a call between a caller and a callee

(75) Inventors: Michael Wayne Brown, Georgetown, TX (US); Joseph Herbert McIntyre, Austin, TX (US); Michael A. Paolini, Austin, TX (US); James Mark Weaver, Austin, TX (US); Scott Lee Winters, Austin, TX (US)

Correspondence Address: Cynthia S. Byrd, Internal Business Machines, Intellectual Property Law, 11400 Burnet Rd., Austin, TX, 78758, US

(73) Assignee: INTERNATIONAL BUSINESS MACHINES CORPORATION, ARMONK, NY

(21) Appl. No.: 10/023,404

(22) Filed: Dec. 17, 2001

(51) Int. Cl. H04M 1/00

(52) U.S. Cl. 455/408; 455/560

(57) ABSTRACT

A method, system, and program for distributing billing for a call between a caller and a callee are provided. Responsive to receiving a call request, a caller billing plan for an authenticated identity of a caller making the call request and a callee billing plan for an authenticated identity of a callee answering the call request are identified and loaded for the call request. Responsive to receiving a request for a billable service with the call request, distributing a cost of the billable service among the caller billing plan and the callee billing plan, such that both the caller and the callee pay for a benefit received from the billable service.

### CROSS-REFERENCE TO RELATED APPLICATIONS

The present application is related to the following copending applications:

(1) U.S. patent application Ser. No. ______/______ (Attorney Docket No. AUS920010818US1);

(2) U.S. patent application Ser. No. ______/______ (Attorney Docket No. AUS920010819US1);

(3) U.S. patent application Ser. No. ______/______ (Attorney Docket No. AUS920010820US1);

(4) U.S. patent application Ser. No. ______/______ (Attorney Docket No. AUS920010821US1);

(5) U.S. patent application Ser. No. ______/______ (Attorney Docket No. AUS920010822US1);

(6) U.S. patent application Ser. No. ______/______ (Attorney Docket No. AUS920010823US1);

(7) U.S. patent application Ser. No. ______/______ (Attorney Docket No. AUS920010838US1);

(8) U.S. patent application Ser. No. ______/______ (Attorney Docket No. AUS920010839US1);

(9) U.S. patent application Ser. No. ______/______ (Attorney Docket No. AUS920010841US1);

(10) U.S. patent application Ser. No. ______/______ (Attorney Docket No. AUS920010842US1); and

(11) U.S. patent application Ser. No. ______/______ (Attorney Docket No. AUS920010843US1).

### BACKGROUND OF THE INVENTION

1. Technical Field

The present invention relates in general to telecommunications and, in particular, to voice identification. Still more particularly, the present invention relates to distributing the billing associated with a call between the caller and the callee.

2. Description of the Related Art

Telephone service has created communication channels worldwide, and those channels continue to expand with the advent of cellular and other wireless services. A person can simply take a telephone off-hook and dial a destination number or press a send button and be connected to a telephone line around the world.

Today, the public switching telephone network (PSTN), wireless networks, and private networks telephone services are based on the identification of the wireless telephone or wireline that a calling party uses. Services are personalized according to wireless telephone or wireline telephone number, where services associated with one telephone number are not accessible for another telephone number assigned to the same subscriber. For example, there is typically a first set of service features and billing options assigned to a home line number, a second set of service features and billing options assigned to an office line number, and a third set of service features and billing options assigned to a cellular telephone number. The networks process calls to and from each of these different subscriber telephones based on a separate telephone number.

In addition to specifying service according to line number, current billing plans require that either the line number originating a call or the line number receiving a call acquire the billing for the call. For example, where long distance service is provided, either the origin line number is billed for the long distance service initiated at the origin line number or the destination line number is billed if a long distance collect call is accepted. Calling cards provide an additional long distance billing option, however, the person utilizing the calling card to make a long distance call incurs the cost of the long distance call.

Therefore, in view of the foregoing, it would be advantageous to provide a method, system, and program for distributing the billing cost of a call among the participants of a call. In addition, it would be advantageous to distribute the cost of a call between the specific caller making a call and the specific callee receiving the call, rather than billing the origin and destination line numbers.

### SUMMARY OF THE INVENTION

In view of the foregoing, it is therefore an object of the present invention to provide an improved telecommunications system.

It is another object of the present invention to provide a method, system and program for improved voice identification.

It is yet another object of the present invention to provide a method, system and program for distributing the billing associated with a call between the caller and the callee.

According to one aspect of the present invention, responsive to receiving a call request, a caller billing plan for an authenticated identity of a caller making the call request and a callee billing plan for an authenticated identity of a callee answering the call request are identified and loaded for the call request. Responsive to receiving a request for a billable service with the call request, distributing a cost of the billable service among the caller billing plan and the callee billing plan, such that both the caller and the callee pay for a benefit received from the billable service.

All objects, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 depicts a block diagram of a network environment in which the present invention may be implemented;

FIG. 2 illustrates a block diagram of the flow of a caller and callee identity authentication in accordance with the method, system, and program of the present invention;

FIG. 3 depicts a block diagram of the flow of billing plans in accordance with the method, system, and program of the present invention;

FIG. 4 illustrates an illustrative representation of the information within billing plans in accordance with the method, system, and program of the present invention;

FIG. 5 depicts a flow diagram of a signal flow and processing of a call in accordance with the method, system, and program of the present invention; and

FIG. 6 illustrates a block diagram of a billing service in accordance with the method, system, and program of the present invention.

### DETAILED DESCRIPTION OF THE PREFERRED EMBODIMENT

A method, system, and program for distributing billing for services provided for a call according to the billing plans of both the caller and the callee are provided. For purposes of the present invention, services may include telephone and generic services available from within a trusted telephone network and services available from servers functioning outside the trusted telephone network, as will be further described.

First, an identity of a caller utilizing the origin device is authenticated. Caller identity authentication may be initiated by the origin device originating the call, the intermediary device processing the call, or the destination device receiving the call. Each of the devices may access a third party or external server to perform the caller identity authentication. Performance of caller identity authentication has different advantages depending on the device initiating the caller identity authentication.

While in the present invention, authentication of a caller identity is described with emphasis placed on voice authentication, other methods of caller identity authentication may also be performed. Voice samples utilized for voice authentication are just one of multiple types of biometric sampling. For example, a caller may locally provide an eye scan, a fingerprint, and other biophysical identifiers that are transmitted within or outside the trusted network to authenticate the identity of the caller. Alternatively, keypad entries, such as a pin code, account number, password, or other secure transaction key may be entered by a caller and utilized to authenticate the identity of the caller.

Next, a caller profile is accessed according to the authenticated identity of the caller utilizing the origin device. The caller profile includes a billing plan selected by the caller. The caller profile may be accessed from a service provider within the trusted telephone network and/or from external servers functioning outside the trusted telephone network, where the caller has selected to disclose caller profile information at those external servers.

Thereafter, the call is transferred to a service provider that will terminate the call at a destination device. The identity of a callee utilizing the destination device is authenticated. As described in the above mentioned references, callee identity authentication may be initiated by the origin device, the intermediary device, or the destination device.

A callee profile is accessed according to the authenticated identity of the callee utilizing the destination device. The callee profile includes a billing plan selected by the callee. The callee profile may be accessed from a service provider within the trusted telephone network and/or from external servers functioning outside the trusted telephone network, where the callee has selected to disclose caller profile information at those external servers.

The caller and callee may then negotiate the portion of the call services that each will pay. A billing service may prompt each caller to select the method for distributing the billing. One method may include distributing a percentage of the total bill among the caller and the callee. Another method may monitoring the time utilized by the caller and the time utilized by the callee during the call and billing according to the percentage of time actually used by each party.

The call is then processed according to the billing plans of both the caller and the callee. Advantageously, by specifying the billing for use of an origin device and a destination device according to the caller and callee utilizing the devices, rather than the line subscribers, the line subscribers are not billed for use of the devices by individuals other than the line subscribers.

In particular, while the present invention is described with reference to a single caller and a single callee, for a call, there may be multiple VIDs or multiple RVIDs. For example, the portion of the cost assigned to the callee, may be distributed among the RVIDs of all the callees.

In addition, while the present invention is described with reference to call services, other types of financial transactions may be split between a caller and a callee, such as where purchases are made via the telephone. Callers and callees may select an account provider in billing plans, where that account provider is charged for products and services requested via the telephone.

For purposes of the present invention, a caller and a callee each preferably subscribe to telephone service from at least one service provider. Each service may be linked to a particular line number, but preferably follows the caller to whichever telephony device the caller chooses to utilize and follows the callee to whichever telephony device the callee chooses to answer. Each service may include a billing plan that provides for services in addition to basic telephone service, at a flat rate. In addition, each billing plan may provide for other services, in addition to basic telephone service, that are billable according to use, such as long distance service. In the present invention, the cost of the services that are billable according to use are those services for which it is most advantageous to distribute costs among the caller and callee.

According to one advantage of the present invention, the cost of long distance service may be distributed among the caller and the callee. According to another advantage of the present invention, the cost of minutes utilized for wireless telephone service may be distributed among the caller and the callee.

For purposes of the present invention, telephony devices are termed origin devices when utilized for origination of a call to an intermediary device and are termed destination devices when utilized for receipt of a call from an intermediary device. Subscribers are termed callers when originating a call and are termed callees when receiving a call.

In the following description, for the purposes of explanation, numerous specific details are set forth to provide a thorough understanding of the present invention. It will be apparent, however, to one skilled in the art that the present invention may be practiced without these specific details. In other instances, well-known structures and devices are shown in block diagram form to avoid unnecessarily obscuring the present invention.

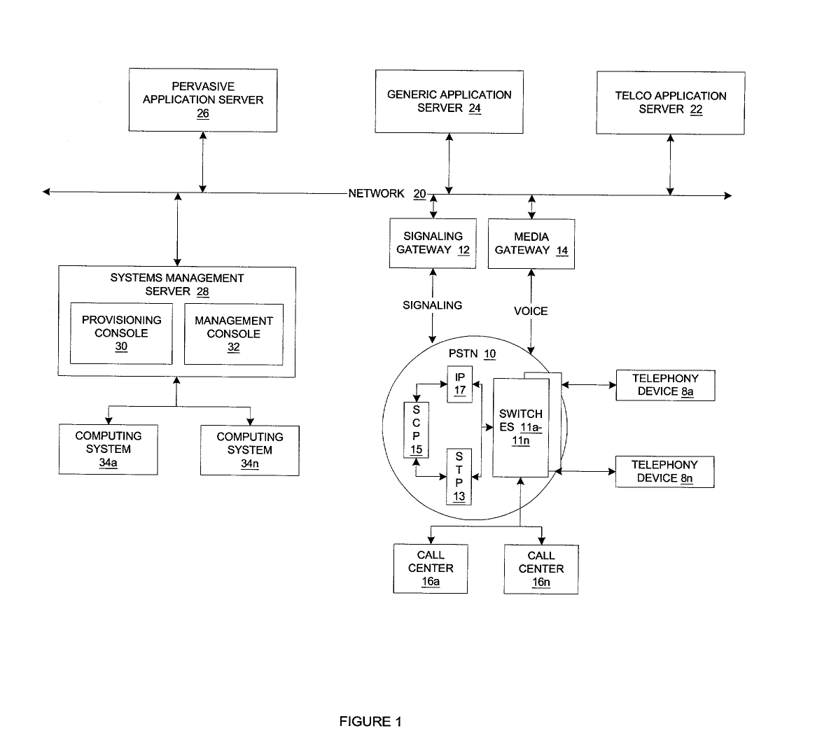

With reference now to the figures, and, in particular, with reference now to FIG. 1, there is depicted a block diagram of a network environment in which the present invention may be implemented. While the present invention is described with reference to one type of network environment, it will be understood by one with skill in the art that the present invention may be implemented in alternate types of network environments.

### General Network Environment

First, the network environment incorporates a Public Switching Telephone Network (PSTN) 10. As is known in the art the core of PSTN 10 may include multiple telephone networks, each owned by one of multiple independent service providers. Each telephone line is carried by an independent service provider within PSTN 10 and is typically assigned to at least one subscriber.

Switching of a call within an independent service provider's telephone network is considered trusted movement within a trusted network because the call remains within the company's telephone network infrastructure. However, calls may be transferred from one service provider's telephone network to another service provider's telephone network in generally trusted movement. Generally, service providers are in competition with one another and therefore there is general trust in transferring a call, but not trust in sharing of subscriber information beyond a subscriber number and name from one service provider to the next without security features or other arrangements.

Advantageously, each telephone network within PSTN 10 may access a data network functioning as an extension to PSTN 10 via an Intranet. Data networks may include, for example, subscriber profiles, billing information, and preferences that are utilized by a service provider to specialize services. Transfer of information between a service provider's data network and telephone network is trusted movement in sharing of information.

Further, each telephone network within PSTN 10 may access server systems external to PSTN 10 in the Internet Protocol over the Internet or an Intranet. Such external server systems may include an enterprise server, an Internet service provider (ISP), an access service provider (ASP), a personal computer, and other computing systems that are accessible via a network. In the present embodiment, transfer of information between PSTN 10 and server systems accessible via a network 20 is untrusted and therefore may require verification and additional security. Network 20 may be preferably considered an external network.

In the present invention, network 20 may comprise a private network, an Intranet, or a public Internet Protocol network. Specifically, telco application server 22, generic application server 24, pervasive application server 26, and systems management server 28 represent server systems external to PSTN 10 that may be accessed by PSTN 10 over network 20.

In particular, telco application server 22 preferably includes multiple telco specific service applications for providing services to calls transferred to a server external to PSTN 10. In particular, a call may be transferred from PSTN 10 to telco application server 22 to receive at least one service and then the call is transferred back to PSTN 10. PSTN 10 preferably brokers the connection between the telephony device and telco application server 22. Such services may also be provided to calls within PSTN 10, however placing such services at a third party such as telco application server 22, is advantageous because adding services and information to PSTN 10 is time consuming and costly when compared with the time and cost of adding the services through telco application server 22.

In accord with an advantage of the present invention, as will be further described, the identity of both the caller and the callee may be authenticated by one of telephony devices 8a-8n, PSTN 10, or by telco application server 22. By authenticating the actual identity of the person making a phone call and the person receiving the phone call, rather than the identification of a device from which a call is made and received, an enhanced specialization of services to subscribers may be performed.

An authentication service within telco application server 22 may include identification and verification of the identity of a caller and/or callee of a particular call. Such a service may require that subscribers provide voice samples when setting up a subscription. The stored voice samples may then be compared against voice samples received for a particular call in order to authenticate the identity of a current caller or callee of the particular call.

Generic application server 24 preferably accesses independent server systems that provide services. For example, a messaging server, a financial server, an Internal Revenue Service (IRS) server, and database management system (DBMS) server may be accessed in HTTP via network 20. Each of these servers may include a telco service application that requires authentication of the subscriber before access is granted. For example, a financial server may provide a telco service application that allows an authenticated subscriber to access current financial records and request stock quotes from the financial server.

Pervasive application server 26 manages services for wirelessly networked devices. In particular, pervasive application server 26 preferably handles distribution of wireless packets of voice and data to wirelessly networked devices utilizing a standard such as short messaging service (SMS) messaging or other 3G standards.

Systems management server 28 manages subscriber personalization via the web. In particular, systems management server 28 includes browser technology that includes a provisioning console 30 for establishing a subscriber profile and a management console 32 for managing and updating the subscriber profile. A subscriber preferably accesses the consoles of systems management server 28 via the Internet utilizing a computing system, such as computing systems 34a-34n.

The subscriber profile may be accessed at systems management server 28 by other external servers and PSTN 10 via network 20. In addition, a local copy of a subscriber profile updated in systems management server 28 may be stored within a particular service provider's data network or telephone network. Each service provider may specify the types of preferences and other information included within a subscriber profile.

In particular, a subscriber may provide a voice imprint when establishing a subscriber profile through provisioning console 30. Other types of authentication information may also be provided including, but not limited to, a password, an eye scan, a smart card ID, and other security devices. In addition, a subscriber may designate billing preferences, shopping preferences, buddy list preferences, and other preferences that enable specialized service to the subscriber when the subscriber's identity is authenticated from the voice imprint or other identification.

Advantageously, a management agent is built into each external server to monitor the services provided by each server according to the authenticated subscriber receiving the services. By monitoring service output according to subscriber, the subscriber may then be billed according to each use of a service.

PSTN 10 preferably includes both voice and data signaling networks that interface with network 20 via gateways. Each of the gateways acts as a switch between PSTN 10 and network 20 that may compress a signal, convert the signal into Internet Protocol (other protocol) packets, and route the packets through network 20 to the appropriate server.

In particular, the voice network interfaces with network 20 through media gateway 14 which supports multiple protocol gateways including, but not limited to, SIP. SIP is a signaling protocol for Internet conferencing, telephony, presence, events notification and instant messaging.

In addition, in particular, the data signaling network interfaces with network 20 through signaling gateway 12 which supports multiple protocol gateways including, but not limited to, parlay protocol gateways and SS7 protocol gateways. Internet servers, such as telco application server 22 may include protocol agents that are enabled to interact with multiple protocols encapsulated in Internet Protocol packets including, but not limited to, SS7 protocol, parlay protocol, and SIP.

### Identity Authentication and Call Control

Looking into PSTN 10, a telephone network typically includes multiple switches, such as central office switches 11a-11n, that originate, terminate, or tandem calls. Central office switches 11a-11n utilize voice trunks for transferring voice communications and signaling links for transferring signals between signaling points.

Between signaling points, one central office switch sends signaling messages to other central office switches via signaling links to setup, manage, and release voice circuits required to complete a call. In addition, between signaling points, central office switches 11a-11n query service control points (SCPs) 15 to determine how to route a call. SCPs 15 send a response to the originating central office switch containing the routing number(s) associated with the dialed number.

SCPs 15 may be general purpose computers storing databases of call processing information. While in the present embodiment SCPs 15 are depicted locally within PSTN 10, in alternate embodiments SCPs 15 may be part of an extended network accessible to PSTN 10 via a network.

One of the functions performed by SCPs 15 is processing calls to and from various subscribers. For example, an SCP may store a record of the services purchased by a subscriber, such as a privacy service. When a call is made to the subscriber, the SCP provides record of the privacy service to initiate an announcement to a caller to identify themself to the subscriber with the privacy service who is being called. According to an advantage of the invention, authentication of the subscriber receiving the call may be required before the privacy service is initiated for that subscriber.

In particular, network traffic between signaling points may be routed via a packet switch called an service transfer point (STP) 13. STP 13 routes each incoming message to an outgoing signaling link based on routing information. Further, in particular, the signaling network may utilize an SS7 network implementing SS7 protocol.

Central office switches 11a-11n may also send voice and signaling messages to intelligent peripherals (IP) 17 via voice trunks and signaling channels. IP 17 provides enhanced announcements, enhanced digit collection, and enhanced speech recognition capabilities.

According to an advantage of the present invention, the identity of a caller is authenticated according to voice authentication. Voice authentication is preferably performed by first identifying a subscriber by matching the name or other identifier spoken with a subscriber name or identifier. Next, voice authentication requires verifying that the voice audio signal matches that of the identified subscriber. However, in alternate embodiments, the identity of a caller may be authenticated according to passwords, eye scans, encryption, and other security devices.

In particular, to perform subscriber authentication of audio signals received from callers, IP 17 may include storage for subscriber specific templates or voice feature information, for use in authenticating subscribers based on speech. If a subscriber specific template is not stored on a local IP 17, then a remote IP containing the subscriber specific template may be accessed via a network. In addition, local IP 17 may access systems management server 28 or another repository for voice imprints to access the subscriber specific template.

Where IP 17 authenticates the identity of a caller (e.g. the subscriber placing a call), a voice identifier (VID) representing the authenticated caller identity is transferred as a signal for identifying the caller. In addition, where IP 17 authenticates the identity of a callee (e.g. the subscriber receiving a call), a reverse VID (RVID) including the callee identity is transfrerred as a signal for identifying the callee.

Alternatively, to perform subscriber authentication of audio signals received from callers, PSTN 10 may broker a caller identity authentication service from telco application server 22. In particular, a signaling channel is opened between central office switches 11a-11n and telco application server 22 via signaling gateway 12. In addition, a voice channel is opened between central office switches 11a-11n and telco application server 22 via media gateway 14.

Because telco application server 22 is located outside of the trusted network, there may be a time delay associated with establishing a connection to telco application server 22 and authenticating the identity of a caller that is longer than a time delay present where a caller identity is authenticated by IP 17.

In addition, because telco application server 22 is located outside of the trusted network, it is advantageous to establish a level of security for transactions between telco application server 22 and central office switches 11a-11n, wherein the level of security is suitable for untrusted communications. A level of security may be implemented by by utilizing security based protocols, such as the secure socket layer, and by applying ordinary encryption. In particular, the level of security preferably protects the communication channel between telco application server and PSTN 10 and authenticates the identity of the server from which a caller identity authentication service is accessed. Therefore an additional feature of signaling gateway 12 and media gateway 14 is security verification.

Advantageously, VIDs indicate through text, voice, or video the identity of a caller. For example, a caller's name may be transferred as the identity of a caller. Alternatively, a video clip stored with the subscriber template may be transferred as the identity of a caller. Additionally, VIDs may indicate the identity of the device utilized by a caller to provide context for a call. Further, VIDs may indicate which system or systems have authenticated the caller identity.

After a VID and/or RVID are determined by IP 17, IP 17 and SCP 15 may communicate to designate which services are available according to VID and RVID. Advantageously, by designating services according to a VID and/or RVID, subscribers are provided with services and billed for those services independent of the devices utilized by subscribers. In particular, a 1129 protocol or other protocol may be utilized to enable signal communications between IP 17 and SCPs 15.

In addition, as previously described, caller authentication to determine VIDs and RVIDs may be performed by an external system, such as telco application server 22. The VID or RVID returned from telco application server 22 may be transferred from central office switches 11a-11n to SCP 15 in order to access a subscriber profile associated with the VID or RVID. Alternatively, the VID or RVID may first transfer to IP 17, where additional verification of the caller identity is performed. For example, IP 17 may control distribution of the VID to the caller, where the caller is prompted to enter a password or additional information. IP 17 may then initiate loading the caller profile into central office switches 11a-11n if the additional caller input is verifiable for the VID.

An origin telephony device or destination telephony device may also determine a VID and/or RVID for the caller and/or callee of a call. In particular, telephony devices 8a-8n and call centers 16a-16n may function as origin and destination telephony devices. Each of the telephony devices may include a database of voice templates that may be matched to authenticate the identity of a caller or callee. In addition, each of the telephony devices may access a third party, such as telco application server 22, to authenticate the identity of the caller or callee. In either case, the telephony device transmits a VID and/or RVID with a call to PSTN 10.

Telephony devices 8a-8n may include, but are not limited to wireline devices, wireless devices, pervasive device equipped with telephony features, a network computer, a facsimile, a modem, and other devices enabled for network communication. Advantageously, as previously described, a voice authentication functioning device may be included in each of telephony devices 8a-8n.

In addition, telephony devices 8a-8n may each incorporate a display that provides a visual output of a VID or RVID. Alternatively, such a display may be provided in a separate device connected to the line in parallel to telephones 8a-8n. According to one advantage of the present invention, the identity of the actual caller or actual callee are output to a display in is association with a call. In addition, other context information about the caller including, but not limited to, the device from which the call originates or is answered, ratings for a caller or callee, and other context information may be output to a display in association with a call.

Telephony devices 8a-8n are communicatively connected to PSTN 10 via wireline, wireless, ISDN, and other communication links. Preferably, connections to telephony devices 8a-8n provide digital transport for two-way voice grade type telephone communications and a channel transporting signaling data messages in both directions between telephony devices 8a-8n and PSTN 10.

In addition to telephony devices 8a-8n, advanced telephone systems, such as call centers 16a-16n, may be communicatively connected to PSTN 10 via wireline, wireless, ISDN and other communication links. Call centers 16a-16n may include PBX systems, hold queue systems, private network systems, and other systems that are implemented to handle distribution of calls to multiple representatives or agents.

Returning to central office switches 11a-11n, typically, one central office switch exists for each exchange or area served by the NXX digits of an NXX-XXXX (seven digit) telephone number or the three digits following the area code digits (NPA) in a ten-digit telephone number. The service provider owning a central office switch also assigns a telephone number to each line connected to each of central office switches 11a-11n. The assigned telephone number includes the area code (NPA) and exchange code (NXX) for the serving central office and four unique digits (XXXX).

Central office switches 11a-11n utilize office equipment (OE) numbers to identify specific equipment, such as physical links or circuit connections. For example, a subscriber's line might terminate on a pair of terminals on the main distribution frame of one of central office switches 11a-11n. The switch identifies the terminals, and therefore a particular line, by an OE number assigned to that terminal pair. For a variety of reasons, a service provider may assign different telephone numbers to the one line at the same or different times. For example, a local carrier may change the telephone number because a subscriber sells a house and a new subscriber moves in and receives a new number. However, the OE number for the terminals and thus the line itself remains the same.

On a normal call, a central office switch will detect an off-hook condition on a line and provide a dial tone. The switch identifies the line by the OE number. The central office switch retrieves profile information corresponding to the OE number and off-hook line. Then, the central office switch receives the dialed digits from the off-hook line terminal and routes the call. The central office switch may route the call over trunks and possibly through one or more central office switches to the central office switch that serves the called party's station or line. The switch terminating a call to a destination will also utilize profile information relating to the destination, for example to forward the call if appropriate, to apply distinctive ringing, etc.

In the present invention, once a VID for a caller is received at one of central office switches 11a-11n, a profile for the caller is requested from SCP 15 or an external server accessible via network 20. The caller profile returned is loaded into a call register of one of central office switches 11a-11n. In particular, depending on the service provider included in a caller profile, the call may be switched to one of central office switches 11a-11n that is associated with the service provider.

In addition, an RVID may be determined in the present invention to authenticate the identity of a callee receiving the call. When a call is answered, the call is transferred back to an IP or telco application server 22 to authenticate the identity of the callee answering the call. Thereafter, one of central office switches 11a-11n terminating the call will load a callee profile for the RVID.

Billing of services request for the call is preferably performed according to a billing plan of both the caller and the callee, where each party has elected to claim a portion of the charges for the call. In addition, services provided for the call are specified according to the service selections of the caller and the callee.

IP 15 or telco application server 22 may prompt the caller and/or callee to select a method for distributing the charges for a call between the caller and callee. For example, where a caller places a long distance call to a callee, IP 15 may prompt the callee to indicate if the callee is willing to pay for a portion of the long distance service charge. If the callee is willing, then the billing for the call is distributed to both the caller and the callee billing plans. In another example, where a caller places a call to a callee at a wireless telephone device, telco application server 22 may prompt the caller to indicate if the caller is willing to pay for a portion of the charge per minute of use of the wireless telephone service by the callee. If the caller is willing, then the billing for the call, and in particular the charges for use of a wireless telephone service, are distributed to both the caller and the callee billing plans.

As another alternative to dialed digits from the off-hook line terminal, a caller may utilize a voice calling function of a telephony device for indicating how the call should be routed. For example, a caller may say the name of a preferred callee. The device or IP 17 may determine a person within the caller's calling list that matches the voiced name. The matching person's digits are then utilized to route the call.

### VID Authentication Context

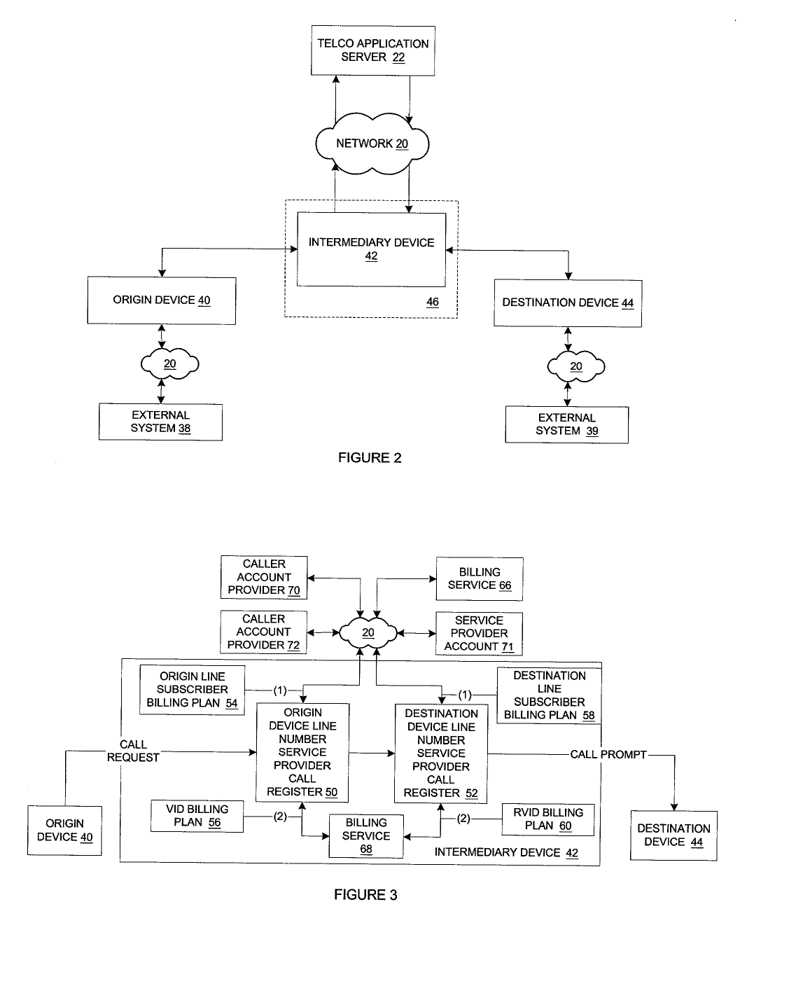

Referring now to FIG. 2, there is illustrated a block diagram of the flow of a caller and callee identity authentication in accordance with the method, system, and program of the present invention.

Origin device 40 is utilized by a caller to initiate a call. The caller is prompted by the device performing caller authentication to provide a voice utterance. A VID for the caller is provided to intermediary device 42 from the device performing caller authentication. The VID is utilized to access a caller profile that includes service preferences and billing information. In addition, the VID is transmitted with the call to destination device 44 for identifying the caller.

In general, caller identity authentication is performed by receiving a voice utterance from a caller, analyzing the voice utterance for sound qualities and content, and attempting to match the sound qualities and content of a voice utterance to a voice template previously recorded for a caller, in order to authenticate the identity of the caller. If there is a match between the voice utterance and a voice template, then a VID is determined for the caller and utilized to authenticate the caller identity for retrieving a caller profile and billing the caller.

Caller identity authentication may be initiated by origin device 40. In particular, origin device 40 may include voice templates and a feature for performing the caller identity authentication. In addition, origin device 40 may access a third party server 48 via network 20, where third party server 48 may provide access to a database of voice templates and/or perform the caller identity authentication. Origin device 40 then transmits a VID determined for the caller to intermediary device 42 for use in specifying services and billing for a call from origin device 40. Origin device 40 may include a caller telephony device, a PBX, a call center, a private switching system, network servers, feature servers, and other systems which provide call origination. Third party server 48 may include a telco application server, a generic application server, a database management system server, and other systems that function outside trusted telephone network 46. In particular, intermediary device 42 may facilitate communication between origin device 40 and network 20.

In addition, caller identity authentication may be initiated by intermediary device 42. Intermediary device 42 may include database systems that store voice templates and an IP for performing caller identity authentication. In addition, intermediary device 42 may access telco application server 22 outside of trusted telephone network 46 via network 20, where telco application server 22 provides a caller authentication service and/or provides access to a database of voice templates. Intermediary device 42 may include a PSTN switching network or networks. However, intermediary device 42 may also include a PBX, a call center, or other private switching system. Further, intermediary device 42 may include network servers, Websphere® (Websphere® is a registered trademark of International Business Machines Corporation) servers, and other systems which provide call processing.

Further, caller identity authentication may be initiated by destination device 44. Destination device 44 may include voice templates and a feature for performing the caller identity authentication. In addition, destination device 44 may access a third party server 49 via network 20, where third party server 49 may provide access to a database of voice templates and/or perform the caller identity authentication. Destination device 44 will prompt a caller to provide a voice utterance at origin device 40, where intermediary device 42 facilitates communications between origin device 40 and destination device 44. Destination device 44 then determines and transmits a VID for the caller to intermediary device 42 for use in specifying services and billing for a call from origin device 40. Destination device 44 may include a callee telephony device, a PBX, a call center, a private switching system, network servers, feature servers, and other systems which provide call receipt. Third party server 48 may include a telco application server, a generic application server, a database management system server, and other systems that function outside trusted telephone network 46. In particular, intermediary device 42 may also facilitate communication between destination device 44 and network 20.

Destination device 44 is utilized by a callee to receive a call. The callee is prompted by the device performing callee authentication to provide a voice utterance. A RVID for the callee is provided to intermediary device 42 from the device performing callee authentication. The RVID is utilized to access a callee profile that includes service preferences and billing information. In addition, the RVID is transmitted to origin device 40 for identifying the callee. Advantageously, callee identity authentication may be initiated by origin device 40, intermediary device 42, or destination device 44, in a similar process as described for caller identity authentication.

In the present invention, a VID and RVID preferably authenticate the identity of a caller and callee. However, it is advantageous that the VID/RVID also include other information that provide a context for a call. For example, the GPS location or time zone of the caller or callee location, the device from which the call is placed or received, the subject matter of the call, and whether the caller is calling on behalf of another, may be included in a VID or RVID. Further, the identity of the device that performed the identity authentication may be included in a VID or RVID.

A VID/RVID may be transferred in multiple protocols, including, but not limited to, Interface Definition Language (IDL). A VID/RVID may include a range of information, where each type of information may be tagged or identified in some other manner. For example, the following tagged VID may be transmitted to represent an authenticated identity of a caller:

[name] Jon Smith

[device] Jane Doe's cell phone

[location] Central Time zone

[service provider] Wireless service provider C

[account provider] Credit account provider H, for long distance charges

[subject] Project A

[authenticated by] Jane Doe's cell phone, service provider G

### Distributed Billing Distribution Context

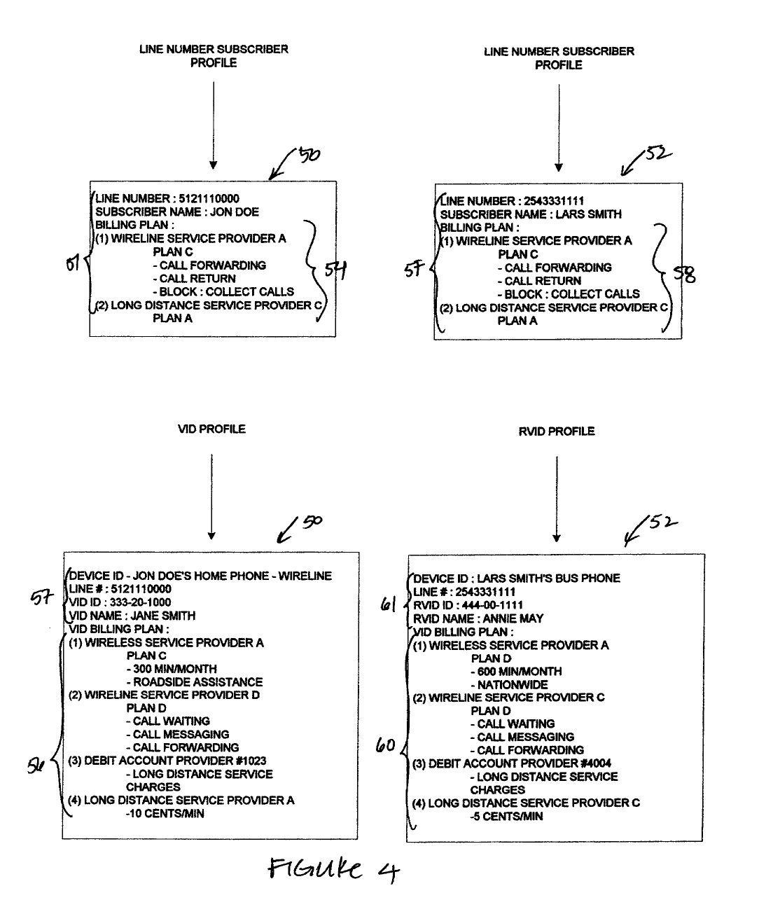

With reference now to FIG. 3, there is depicted a block diagram of the flow of a billing plan in accordance with the method, system, and program of the present invention. As illustrated, origin device 40 transfers a call request to intermediary device 42. The call request may be an off-hook condition for a wireline device and a network service connection request for a wireless device.

Initially, intermediary device 42 will respond to a call request by establishing a call register 50 for the call. In particular, a service provider that provides a line number accessed by origin device 40 will establish call register 50.

Next, intermediary device 42 will respond by accessing the profile for the subscriber line associated with origin device 40. In the example, the profile includes origin line subscriber billing plan 54 that is accessed and loaded into call register 50. Origin line subscriber billing plan 54 may be accessed from a database within intermediary device 42 or by accessing a database outside trusted telephone network 46.

However, once a VID is determined for the call, intermediary device 42 will respond by accessing the profile for the VID. In the example, the VID profile includes a VID billing plan 56 that is accessed and loaded into call register 50. VID billing plan 56 may replace or supplement origin line subscriber billing plan 54 within call register 50. The call is then initially processed according to the billing plans available in call register 50.

VID billing plan 56 may be accessed from a VID based caller profile stored within a database accessible within trusted telephone network 46. In addition, VID billing plan 56 may be accessed from servers external to trusted telephone network 46. In particular, a caller may choose to disclose billing information at multiple locations external to trusted telephone network 46. In addition, a caller may choose to change billing information at systems management server 28 and other servers external to trusted telephone network 46. For example, a caller may access management console 32 within systems management server to update service and billing preferences according to VID. Intermediary device 42 may then access systems management server 28 to obtain billing information according to VID.

In processing the call, intermediary device 42 will look up the service provider assigned to the destination line number provided by the caller and transfer the call to the next service provider if needed. The service provider assigned to the destination line number may or may not be be the same as the service provider assigned to the origin line number.

A call register 52 is established to terminate the call to destination device 44. In particular, a destination line subscriber plan 58 is loaded into call register 52 in association with the destination line number. However, once an RVID is received for the callee at destination device 44, a profile for the RVID is accessed and loaded into call register 52. The services and billing plan for the callee are available for processing the call. While call register 50 and call register 52 are depicted as independent registers, in alternate embodiments, the call registers may be consolidated into a single unit.

In particular, a billing plans may include multiple service provider selections by each caller and each callee. For example, a caller may select a wireline service provider and a wireless service provider, in addition to a long distance service provider. Advantageously, when a caller profile is loaded into a register, if a service provider is selected other than the one currently handling the call, the call may be transferred to that service provider. Where multiple service providers are elected, the service provider providing the type of general telephone service requested is utilized. For example, if a wireless service provider receives the call, then the wireless provider election in the caller provider is utilized. As a call is switched from one service provider to another, tariffs may be charged to the caller or new service provider.

A billing service then accesses the billing plans of the caller and callee to control distribution of charges for a call. By accessing the billing plans of the caller and callee accounts to which charges for telephone services may be charged are accessed. A caller may be billed for charges associated with services selected by the caller, such as long distance service. A callee may be billed for charges associated with services selected by the caller, such as a collect call service.

In particular, the billing service may be located in a telco application service accessible outside trusted telephone network 46, such as billing service 66. Alternatively, the billing service may be located in an Intelligent Peripheral within trusted telephone network 46, such as billing service 68.

According to an advantage of the present invention, callers and callees may also elect to split the cost of services typically applied to one party or the other. The billing service may prompt the caller and callee to elect portions of payment. Alternatively, caller and callee profiles may indicate billable portion elections.

The billing service preferably tracks usage and facilitates the split payment. Account providers and service providers may be elected within a billing plan to be charged for the telephone service costs. Payments may include a monetary amount, points, minutes, or over unit that has value. For example, a per minute charge may be made to an account provider that provides a charge or debit account. In another example, a minute for minute charge may be made to a wireless service provider from which a caller has purchased a particular number of tradeable minutes.

In the present example, the billing service may also facilitate payment from a caller account provider 70 to a callee account provider 72 or vice versa. A service provider for the callee may charge the callee for the full cost of a service, but then the billing service apportions the cost of the service and facilitates transfer of the apportioned monetary amount from caller account provider to callee account provider 72. Alternatively, the billing service may negotiate for a caller service provider to pay a callee service provider and charge the caller for the reimbursement. Further, the billing service may negotiate for caller account provider 72 to pay a service provider account 71.

Advantageously, account providers may store accounts according to VID and RVID, such that while the identity of a caller or callee is distributed during a call, the account numbers of the caller and callee remain protected at account providers. By utilizing a single identifier to represent an individual, that individual need not reenter personal and account information for each call and the authenticated identifier automatically authorizes transactions.

A caller or callee may elect for a particular call to initiate the billing service to distribute the charges for services provided for a call. Alternatively, a caller or callee profile may designate a preference to split billing and may further indicate contexts in which split billing is preferred. For example, a list of callee identifiers may be included in a caller profile, where the caller prefers to automatically initiate the billing service if a call is placed to one of those callees. In addition, a caller profile may indicate that for calls outside of a calling area, for split billing to be initiated.

In particular, there are some services where distribution of the charges for the services is particularly advantageous. Services that may be advantageous to distribute charges for include, but are not limited to, long distance services, calling card services, collect call services, wireless telephone services, conference calling services, and other services which are charged for on a rate or use basis rather than being included within a flat monthly fee.

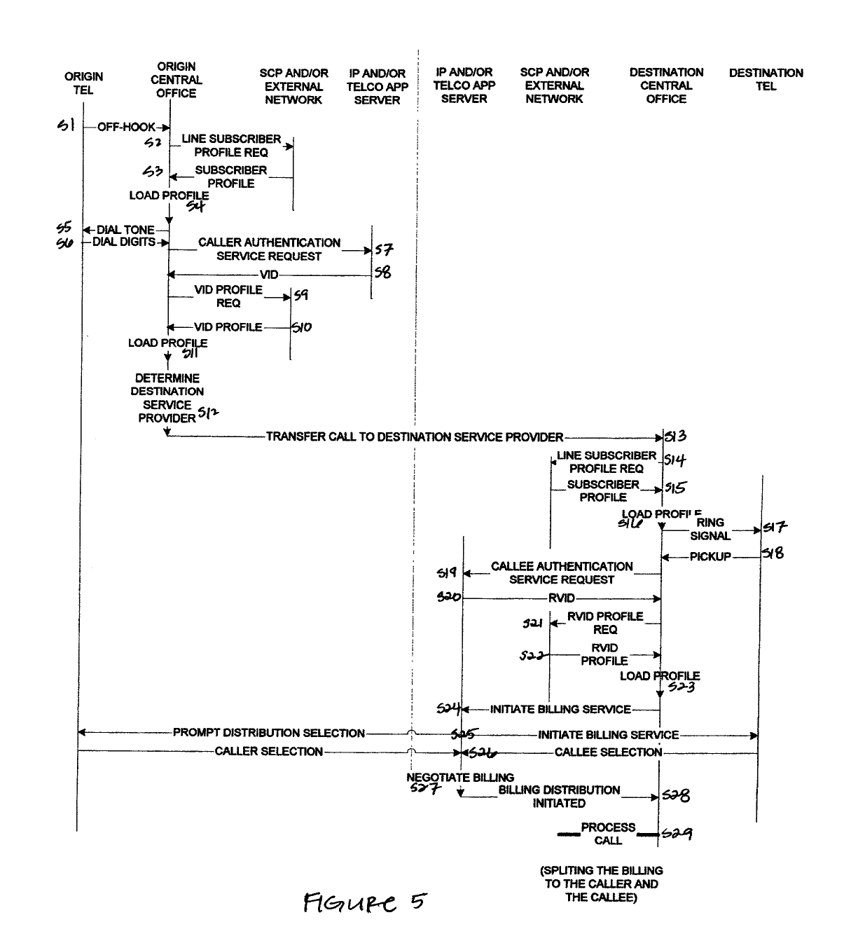

Referring now to FIG. 4, there is an illustrative representation of the information within billing plans in accordance with the method, system, and program of the present invention.

In the example, in response to an origin line subscriber profile request, an origin line subscriber profile 51 is returned and stored within call register 50. In the example, origin line subscriber profile 51 indicates the line number, the name of the subscriber assigned to a line number, and origin line subscriber billing plan 54.

Origin line subscriber billing plan 54 may include information including, but not limited to, selected service providers and other account providers. A billing plan may include one service provider utilized for general wireline service and another service provider utilized for long distance service. Further, a billing plan may include other account providers, such as a debit account provider for charging for use of a call return service or a collect call. Charges may be distributed to each of the service providers and account providers depending on the type of charge and the type of account.

According to an advantage of the present invention, the billing information for a call in call register 50 may be supplemented or replaced by VID billing plan 56. In the example, the billing information for the VID replaces the billing information for the origin line subscriber, such that service provided to the caller may be billed to the caller, rather than the line subscriber.

In addition to billing information, VID and context information 57 may also be added to call register 50. In the example, VID and context information 57 includes a VID ID, a VID name, the line number, and an identifier for the device. In alternate embodiments, additional billing, VID, and call context information may be included in call register 50. In particular, where the origin line subscriber and the caller are the same person, it is still advantageous to supplement call register 50 with VID and context information 57.

According to one advantage of the present invention, an origin device is not limited to the services elected by the line subscriber. In addition, billing for use of a line number is not limited to billing the line subscriber, particularly where use of a line number is billed per minute.

In addition, in the example, in response to a destination line subscriber profile request, a destination line subscriber profile 57 is returned and stored within call register 52. In the example, destination line subscriber profile 57 indicates the destination line number, the name of the subscriber assigned to a line number, and destination line subscriber billing plan 58.

According to an advantage of the present invention, the billing information for a call in call register 52 may be supplemented or replaced by RVID billing plan 60. In the example, the billing information for the RVID replaces the billing information for the destination line subscriber, such that service provided to the callee may be billed to the caller, rather than the line subscriber.

In addition to billing information, RVID and context information 61 may also be added to call register 52. In the example, RVID and context information 61 includes a RVID ID, a RVID name, the line number, and an identifier for the device. In alternate embodiments, additional billing, RVID, and call context information may be included in call register 52. In particular, where the destination line subscriber and the callee are the same person, it is still advantageous to supplement call register 52 with VID and context information 61.

Once the billing plan for the caller and callee have been loaded into call registers 50 and 52, then negotiations may start for distribution of charges associated with service provided for the call. The service provider or telco application service providing a billing service preferably tracks the charges, such that the charges are distributable among the caller and callee according to billing plans designated for each.

In the example, if a charge for a long distance service is being distributed, long distance service provider A provides the service, according to VID billing plan 56. However, a billing service negotiates payment of half of the cost of the long distance service charge to long distance service provider A from a debit account provider selected in RVID billing plan 60. The callee preferably establishes a debit account according to RVID, and designates that long distance service charges may be charged to the debit account. The callee may deposit a particular amount of money or pay for a particular number of minutes in the debit account.

In another example, the long distance service provider selected by the callee may offer a better rate than the long distance service provider selected by the caller. The billing service would preferably transfer the call to the callee long distance service provider and bill the caller for the distributed cost of the long distance service. In particular, the caller long distance service provider may be billed according to the caller VID. Alternatively, a credit or debit account established by the caller may be billed.

With reference now to FIG. 5, there is depicted a flow diagram of a signal flow and processing of a call in accordance with the method, system, and program of the present invention. A standard telephone device is assumed for the Atel@ origin device in the present example. However, a similar signal flow may be applied to other types of origin devices.

The caller lifts a handset creating an off-hook state in the origin device and a corresponding change in state of an off-hook signal to the origin central office (step S1). In response to detecting an off-hook state in the origin device, the origin central office establishes a register for the call and requests a line subscriber profile from the SCP and/or an external network server (step S2). A line subscriber profile including preferred services and a billing plan is returned to the origin central office (step S3). The central office loads the line subscriber profile into the call register (step S4) and extends a dial tone to the origin device (step S5).

The origin device then transmits dialed digits to the origin central office (step S6). A caller may utilize a keypad to enter a telephone number or utilize a voice dial feature if available. Dialed digits may be received at other points in the process and loaded into the call register until needed for processing the call.

Next, the origin central office extends a caller authentication service request to an IP or to the telco application server (step S7). The caller authentication server will prompt a caller to provide a voice utterance, match the voice utterance with a voice template and authenticate the caller identity as a VID which is returned to the central office (step S8). Alternatively, the origin device or destination device may perform caller authentication, where the VID is received from the origin device or destination device.

The origin central office updates the call register with the VID and extends a request for a VID based profile to the SCP and/or external network servers (step S9). The VID based profile is returned from locations where the caller has selected to make VID based information available (step S10). The origin central office then loads the VID based profile, including service preferences and billing information, into the call register (step S11). In particular, if a service provider indicated in a caller billing plan is different than the service provider providing the line, then the call may be transferred to the service provider indicated in the caller billing plan, where a new call register is created in the central office of the caller billing service provider.

Next, the origin central office determines the destination service provider for dialed digits (step S12). The origin central office may access a directory that indicates which service provider is assigned to the dialed digits. The call is then transferred to the destination service provider central office (step S13). In particular, alternatively, the origin service provider and destination provider may be the same, such that a call need not be transferred.

The destination central office establishes a call register for the call and triggers a request to the SCP or an external network server for a line subscriber profile for the destination line number (step S14). The line subscriber profile is returned, including billing information and service preferences (step S15). The destination central office loads the destination line subscriber profile into the call register (step S16) and extends a ring signal with the call to the destination device (step S17).

In response to detecting a pickup of the destination device, an off-hook pickup signal is returned from the destination device to the destination central office (step S18). Next, the destination central office extends a callee authentication service request to an IP or to the telco application server (step S19). The callee authentication server will prompt a callee to provide a voice utterance, match the voice utterance with a voice template and authenticate the callee identity as a RVID which is returned to the destination central office (step S20). Alternatively, the origin device or destination device may perform caller authentication, where the RVID is received at the destination central office from the origin device or destination device.

The destination central office updates the call register with the RVID and extends a request for a RVID based profile to the SCP and/or external network servers (step S21). The RVID based profile is returned from locations where the caller has selected to make RVID based information available (step S22). The destination central office then loads the RVID based profile, including service preferences and billing information, into the call register (step S23).

Next, depending on the services requested by a caller or callee, a billing service provided by the IP or the telco application server may be triggered by the destination central office (step S24). The destination central office may trigger the billing service according to a callee request or according to preferences in the caller or callee profile. Alternatively, the origin central office may trigger the cost distribution service, as requested by a caller or indicated by preferences within the caller profile.

The device providing the billing service preferably transfers a prompting instruction to the origin device and/or destination device (step S25). The prompting instruction will indicate the type of service requested, the billable rate for the service, and options for selecting to pay for a portion of the charges for the service. Where a caller initiates long distance service, the callee may be prompted to select whether to participate in the charges for the long distance service. Where the caller initiates a call to a callee, where the destination device utilizes wireless telephone service, the caller may be prompted to select whether to participate in the charges for the wireless telephone service. Other types of services may require prompting both the caller and the callee.

The caller and/or callee return a distribution selection from the origin device and/or destination device to the billing service (step S26). The billing service may then negotiate between the service and account providers indicated in the VID profile and RVID profile to determine which providers will provide the service and at what rate (step S27). The billing service may transmit instructions to the destination central office and/or origin central office indicating that the billing distribution process has been initiated (step S28). Thereafter, the billing service may monitor use of the billable service and charge the billing plans of the caller and callee according to billing distribution selections.

The call is then processed to facilitate communications between the origin device and the destination device accessed in association with the dialed digits (step S29). In particular, processing the call also includes providing services designated in the VID and RVID based profiles and billing for services to both the caller and the callee. The cost of some services may be distributed among both the caller and the callee.

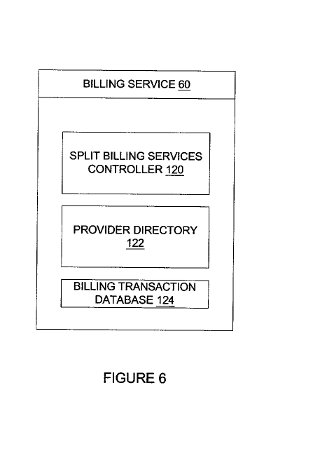

Referring now to FIG. 6, there is depicted a block diagram of a billing service in accordance with the method, system, and program of the present invention. As illustrated, billing service includes a split billing services controller 120. Controller 120 preferably processes requests for a split bill, facilitates payments of a split bill, and records split billing transactions.

A provider directory 122 preferably includes network addresses of account and service providers to enable controller 120 to facilitate billing to account and service providers. In addition, provider directory 122 may include ratings for account and service providers according to reliability in previous financial transactions.

A billing transaction database 124 preferably stores records of split billing transactions facilitated by controller 120. In particular, records may be stored according to VID or RVID for reference in future transactions.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

While the invention has been particularly shown and described with reference to a preferred embodiment, it will be understood by those skilled in the art that various changes in form and detail may be made therein without departing from the spirit and scope of the invention.

What is claimed is:

1. A method for billing for telephone services, said method comprising:
responsive to receiving a call request, identifying and loading a caller billing plan for an authenticated identity of a caller making said call request and a callee billing plan for an authenticated identity of a callee answering said call request; and
responsive to detecting a billable service with said call request, distributing a cost of said billable service among said caller billing plan and said callee billing plan, such that both said caller and said callee pay for a benefit received from said billable service.

2. The method for billing for telephone services according to claim 1, wherein said billable service comprises at least one from among a long distance service, a collect calling service, and a wireless telephone service.

3. The method for billing for telephone services according to claim 1, further comprising:
receiving said call request from an origin device at a service provider from an origin line number utilized by said origin device;
loading a profile for a line subscriber of said origin line number, wherein said profile comprises a billing plan for said line subscriber;
extending a dial tone to said origin device;
authenticating said identity of said caller utilizing said origin device;
loading said caller billing plan according to said authenticated identity to replace said billing plan for said line subscriber;
loading a profile for a destination line subscriber of a requested destination line number, wherein said profile comprises a billing plan for said destination line subscriber;
extending a ring signal to a destination device via said destination line number;
responsive to detecting an answer at said destination device, authenticating said identity fo said callee utilizing said destination device; and
loading said callee billing plan according to said authenticated identity to replace said billing plan for said destination line subscriber.

4. The method for billing for telephone services according to claim 1, wherein said authenticated identity of said caller is authenticated according to a voice utterance provided by said caller.

5. The method for billing for telephone services according to claim 1, wherein said authenticated identity of said callee is authenticated according to a voice utterance provided by said callee.

6. The method for billing for telephone services according to claim 1, wherein authenticating an identity of a caller further comprises:
initiating authentication of said identity of said caller and said callee at an origin device, wherein said origin device is enabled to initiate said call request.

7. The method for billing for telephone services according to claim 1, wherein authenticating an identity of a caller further comprises:
initiating authentication of said identity of said caller and said callee at an intermediary device processing said call Request.

8. The method for billing for telephone services according to claim 1, wherein authenticating an identity of a caller further comprises:
initiating authentication of said identity of said caller and said callee at a destination device, wherein said destination device is enabled to receive said call request.

9. The method for billing for telephone services according to claim 1, further comprising:
switching said call request from a first service provider associated with said caller billing plan to a second service provider associated with said callee billing plan.

10. The method for billing for telephone services according to claim 1, wherein said caller is also a line subscriber of a line number utilized by said caller to make said call request.

11. The method for billing for telephone services according to claim 1, wherein said caller is different from a line subscriber of a line number utilized by said caller to make said call request.

12. The method for billing for telephone services according to claim 1, wherein said callee is also a line subscriber of a line number utilized by said callee to receive said call request.

13. The method for billing for telephone services according to claim 1, wherein said callee is different from a line subscriber of a line number utilized by said callee to receive said call request.

14. The method for billing for telephone services according to claim 1, further comprising:
extending a request to said caller to elect to pay for a portion of said cost of said billable service; and
billing said caller billing plan according to said payment election.

15. The method for billing for telephone services according to claim 1, further comprising:
extending a request to said callee to elect to pay for a portion of said cost of said billable service; and
billing said callee billing plan according to said payment election.

16. The method for billing for telephone services according to claim 1, further comprising:
distributing said cost of said billable service evenly between said caller billing plan and said callee billing plan.

17. The method for billing for telephone services according to claim 1, further comprising:
distributing said cost of said billable service to each of said caller billing plan and said callee billing plan according to actual percentage use by each of said caller and said callee.

18. A system for billing for telephone services, said system comprising:
a network controller;
means responsive to receiving a call request, for identifying and loading a caller billing plan for an authenticated identity of a caller making said call request and a callee billing plan for an authenticated identity of a callee answering said call request at said network controller; and
means responsive to detecting a billable service with said call request, for distributing a cost of said billable service among said caller billing plan and said callee billing plan.

19. The system for billing for telephone services according to claim 18, wherein said billable service comprises at least one from among a long distance service, a collect calling service, and a wireless telephone service.

20. The system for billing for telephone services according to claim 18, further comprising:
means for receiving said call request from an origin device at a service provider from an origin line number utilized by said origin device;
means for loading a profile for a line subscriber of said origin line number, wherein said profile comprises a billing plan for said line subscriber;
means for extending a dial tone to said origin device;
means for authenticating said identity of said caller utilizing said origin device;
means for loading said caller billing plan according to said authenticated identity to replace said billing plan for said line subscriber;
means for loading a profile for a destination line subscriber of a requested destination line number, wherein said profile comprises a billing plan for said destination line subscriber;
means for extending a ring signal to a destination device via said destination line number;
means responsive to detecting an answer at said destination device, for authenticating said identity fo said callee utilizing said destination device; and
means for loading said callee billing plan according to said authenticated identity to replace said billing plan for said destination line subscriber.

21. The system for billing for telephone services according to claim 18, wherein said authenticated identity of said caller is authenticated according to a voice utterance provided by said caller.

22. The system for billing for telephone services according to claim 18, wherein said authenticated identity of said callee is authenticated according to a voice utterance provided by said callee.

23. The system for billing for telephone services according to claim 18, wherein said means for authenticating an identity of a caller further comprises:
means for initiating authentication of said identity of said caller and said callee at an origin device, wherein said origin device is enabled to initiate said call request.

24. The system for billing for telephone services according to claim 18, wherein said means for authenticating an identity of a caller further comprises:
means for initiating authentication of said identity of said caller and said callee at an intermediary device processing said call request.

25. The system for billing for telephone services according to claim 18, wherein said means for authenticating an identity of a caller further comprises:
means for initiating authentication of said identity of said caller and said callee at a destination device, wherein said destination device is enabled to receive said call request.

26. The system for billing for telephone services according to claim 18, further comprising:
means for switching said call request from a first service provider associated with said caller billing plan to a second service provider associated with said callee billing plan.

27. The system for billing for telephone services according to claim 18, wherein said caller is also a line subscriber of a line number utilized by said caller to make said call request.

28. The system for billing for telephone services according to claim 18, wherein said caller is different from a line subscriber of a line number utilized by said caller to make said call request.

29. The system for billing for telephone services according to claim 18, wherein said callee is also a line subscriber of a line number utilized by said callee to receive said call request.

30. The system for billing for telephone services according to claim 18, wherein said callee is different from a line subscriber of a line number utilized by said callee to receive said call request.

31. The system for billing for telephone services according to claim 18, further comprising:
means for extending a request to said caller to elect to pay for a portion of said cost of said billable service; and
means for billing said caller billing plan according to said payment election.

32. The system for billing for telephone services according to claim 18, further comprising:
means for extending a request to said callee to elect to pay for a portion of said cost of said billable service; and
means for billing said callee billing plan according to said payment election.

33. The system for billing for telephone services according to claim 18, further comprising:
means for distributing said cost of said billable service evenly between said caller billing plan and said callee billing plan.

34. The system for billing for telephone services according to claim 18, further comprising:
means for distributing said cost of said billable service to each of said caller billing plan and said callee billing plan according to actual percentage use by each of said caller and said callee.

35. A computer program product for billing for telephone services, said computer program product comprising:
a recording medium;
means, recorded on said recording medium, for identifying and loading a caller billing plan for an authenticated identity of a caller making a call request and a callee billing plan for an authenticated identity of a callee answering said call request; and
means, recorded on said recording medium, for distributing a cost of a billable service for said call request among said caller billing plan and said callee billing plan.

36. The computer program product for billing for telephone services according to claim 35, further comprising:
means, recorded on said recording medium, for receiving said call request from an origin device at a service provider from an origin line number utilized by said origin device;
means, recorded on said recording medium, for loading a profile for a line subscriber of said origin line number, wherein said profile comprises a billing plan for said line subscriber;
means, recorded on said recording medium, for extending a dial tone to said origin device;
means, recorded on said recording medium, for authenticating said identity of said caller utilizing said origin device;
means, recorded on said recording medium, for loading said caller billing plan according to said authenticated identity to replace said billing plan for said line subscriber;
means, recorded on said recording medium, for loading a profile for a destination line subscriber of a requested destination line number, wherein said profile comprises a billing plan for said destination line subscriber;
means, recorded on said recording medium, for extending a ring signal to a destination device via said destination line number;
means, recorded on said recording medium, for authenticating said identity of said callee utilizing said destination device; and
means, recorded on said recording medium, for loading said callee billing plan according to said authenticated identity to replace said billing plan for said destination line subscriber.

37. The computer program product for billing for telephone services according to claim 35, further comprising:
means, recorded on said recording medium, for initiating authentication of said identity of said caller and said callee at an origin device, wherein said origin device is enabled to initiate said call request.

38. The computer program product for billing for telephone services according to claim 35, further comprising:
means, recorded on said recording medium, for initiating authentication of said identity of said caller and said callee at an intermediary device processing said call request.

39. The computer program product for billing for telephone services according to claim 35, further comprising:
means, recorded on said recording medium, for initiating authentication of said identity of said caller and said callee at a destination device, wherein said destination device is enabled to receive said call request.

40. The computer program product for billing for telephone services according to claim 35, further comprising:
means, recorded on said recording medium, for switching said call request from a first service provider associated with said caller billing plan to a second service provider associated with said callee billing plan.

41. The computer program product for billing for telephone services according to claim 35, further comprising:
means, recorded on said recording medium, for extending a request to said caller to elect to pay for a portion of said cost of said billable service; and
means, recorded on said recording medium, for billing said caller billing plan according to said payment election.

42. The computer program product for billing for telephone services according to claim 35, further comprising:
means, recorded on said recording medium, for extending a request to said callee to elect to pay for a portion of said cost of said billable service; and
means, recorded on said recording medium, for billing said callee billing plan according to said payment election.

43. The computer program product for billing for telephone services according to claim 35, further comprising:
means, recorded on said recording medium, for distributing said cost of said billable service evenly between said caller billing plan and said callee billing plan.

44. The computer program product for billing for telephone services according to claim 35, further comprising:
means, recorded on said recording medium, for distributing said cost of said billable service to each of said caller billing plan and said callee billing plan according to actual percentage use by each of said caller and said callee.
